(19) United States
(12) Patent Application Publication
(10) Pub. No.: US 2007/0074401 A1
(43) Pub. Date: Apr. 5, 2007

(54) Taping knife handle with identification insert

(76) Inventors: Matthew Earle Myers, Naperville, IL (US); Scott Fong, Hong Kong (HK)

Correspondence Address: GREER, BURNS & CRAIN, LTD., 300 SOUTH WACKER DRIVE, SUITE 2500, CHICAGO, IL, 60603, US

(21) Appl. No.: 11/328,530

(22) Filed: Jan. 10, 2006

Related U.S. Application Data
(63) Continuation-in-part of application No. 11/187,582, filed on Jul. 22, 2005.

(51) Int. Cl. B26B 3/00; B26B 11/00

(52) U.S. Cl. 30/142

(57) ABSTRACT

A handle for a taping knife having a blade with a working edge and an attachment edge opposite the working edge, the handle including a handle core with distal and proximal ends, the proximal end associated with the attachment edge, the core defining a recess, and at least one identification insert insertable into the handle core recess.

### RELATED APPLICATION

This application is a Continuation-in-Part of U.S. Ser. No. 11/187,582, filed Jul. 22, 2005.

### BACKGROUND OF THE INVENTION

The present invention generally relates to hand tools, and more particularly to a taping knife of the type used to finish wallboard construction projects.

Taping knives or tools (the terms are considered interchangeable), which have varying blade widths, are used to finish wallboard construction projects and create a smooth transition between abutting wallboard surfaces. After wallboard panels are in place, a smaller (e.g. 4-6 inch) taping knife is generally used to apply a settable joint compound and drywall tape to the joints formed by the abutting wallboard surfaces. At this stage, unseated nails must also be finally set into the wallboards and supporting studs. After the joint compound dries, progressively larger (e.g. 8 inch-14 inch) knives are used to apply more compound to the joint areas. This step is repeated, with intermittent sanding steps, until the joint is sufficiently flat and smooth.

Present taping knives often use wood or plastics, such as glass-filled nylons or polyolefins for the handle. However, the low coefficient of friction on the smooth outer surface of conventional handles allows slippage of the knife in the user's hand, particularly when the hand becomes wet from perspiration or joint compound. Also, users with smaller hands have difficulty holding conventional taping knives during prolonged use.

While it is known to provide taping knives with a hammer element at the end of the handle for setting nails or other objects, many conventional knives do not have such hammer elements, and the knives that have hammer elements typically cap off the handle. Many of the workers that use conventional taping knives will set the nail prior to applying joint compound by striking the nail with the side of the handle perpendicular to the nail instead of striking the nail axially with respect to the handle as the tool is intended to be used. This improper use can cause the handle to crack, requiring the replacement of the knife. Also, it is not uncommon for users' hands to slip on the handle during the hammering operation and become pinched between the tool and the wall.

Performing a wallboard joint finishing job generally requires the use of several taping knives, as described above, and depending on the size of the project, can also involve the employment of several drywall workers. As is the case with other skilled tradesmen, wallboard tapers are often very possessive of their tools. When multiple tapers are present on a job, taping knives can become difficult to identify by their users at a job site, because they tend to look very similar to each other. In addition, especially after prolonged use, it becomes difficult to identify the manufacturer of taping knives because of their similarities in appearance.

Consequently, there is a need in the home improvement and/or home-decorating industries for an improved taping knife with improved gripping characteristics and an identification system which address the above-identified drawbacks.

### BRIEF SUMMARY OF THE INVENTION

The above-listed needs are met or exceeded by the present taping knife, which features an identification insert insertable into a handle of the taping knife for identification purposes. The insert is preferably of a pre-selected color so that the user can easily identify his/her particular taping knife.

More specifically, the present handle for a taping knife including a blade having a working edge and an attachment edge opposite the working edge has a handle including a handle core with distal and proximal ends, the proximal end associated with the attachment edge, the core defining a recess, and at least one identification insert insertable into the handle core recess.

An identification kit for the present taping knife is also provided, the identification kit including a knife with a plurality of identification inserts, each of the inserts individually insertable into the handle core recess.

### BRIEF DESCRIPTION OF THE SEVERAL VIEWS OF THE DRAWINGS

FIG. 1 is a front view of the present taping knife with an identification insert in the handle, with portions omitted for clarity;

FIG. 2 is a cross-section taken along the line 2-2 shown in FIG. 1 in the direction generally indicated;

FIG. 3 is an exploded top perspective view of the present taping knife;

FIG. 4 is a top perspective view of the hammer element;

FIG. 5 is a top perspective view of the present taping knife with the identification insert in the handle;

FIG. 6 is a cross-section taken along the line 6-6 shown in FIG. 1 in the direction generally indicated;

FIG. 7 is a side view of an insert insertable into a handle of the present taping knife;

FIG. 8 is a top view of the insert of FIG. 7; and

FIG. 9 is a top view of the insert of FIG. 7 as it appears in the handle of an alternate embodiment of the present taping knife.

### DETAILED DESCRIPTION OF THE INVENTION

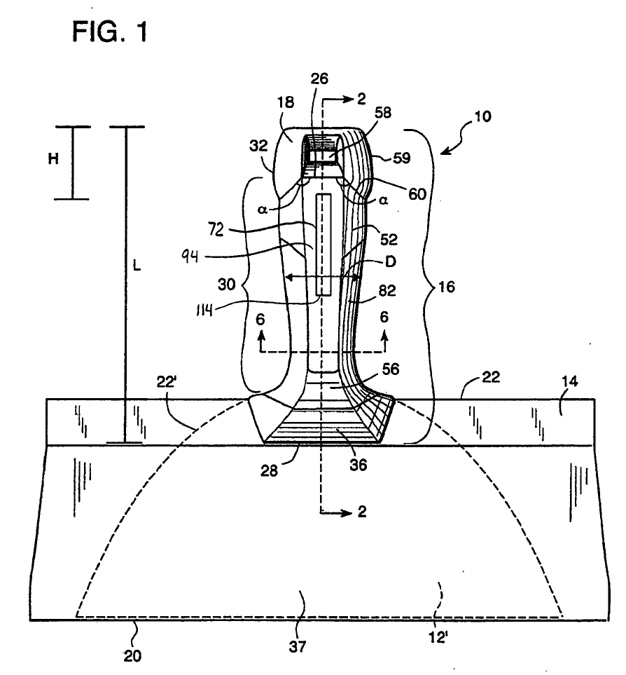

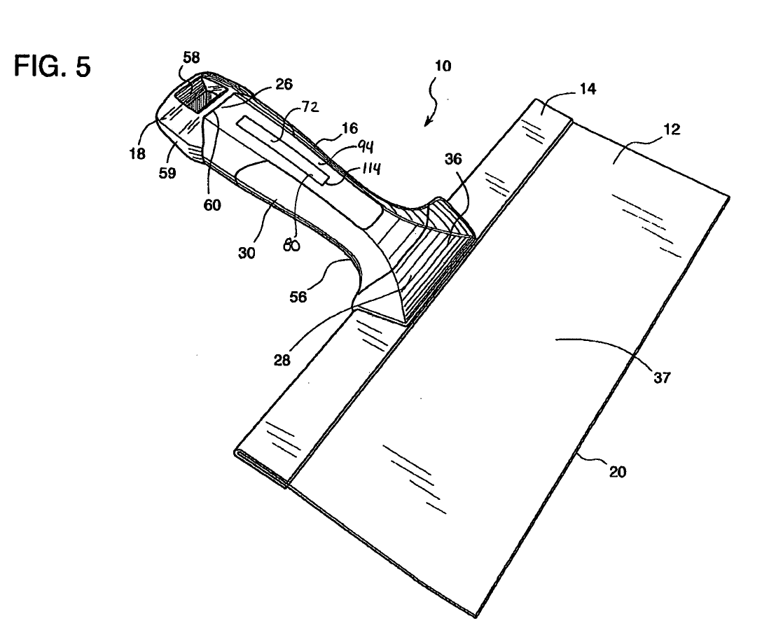

Referring to FIGS. 1 and 5, a taping knife generally designated 10 is preferably constructed of a flat metal blade 12, a reinforcing backing plate 14, a handle 16, and a hammer element 18. The blade 12 has a working edge 20 and an attachment edge 22 opposite the working edge 20. While other materials are contemplated, the blade 12 is preferably made of blued steel and the reinforcing backing plate 14 of aluminum. The shape of the blade 12 is as shown in FIG. 1, but it is envisioned that the handle 16 is usable with shorter blades 12′ having a curved attachment edge 22′ (shown in phantom in FIG. 1), and lacking a reinforcing backing plate 14 as are well known in the art. Furthermore, other blade shapes are contemplated, either with or without a reinforcing backing plate 14.

The handle 16 has at least one diameter D and includes distal 26 and proximal ends 28 and a body 30, the proximal end 28 is associated with the attachment edge 22. A feature of the present knife 10 is the configuration of the hammer element 18, which is associated with the distal end 26 and is preferably but not necessarily made of a harder material relative to the handle 16. Here, “associated with” means that the hammer element 18 will be attached to the distal end 26. However, it is foreseeable that the hammer element 18 and the distal end 26 may not be in direct contact. The same applies to the proximal end 28.

A periphery 32 of the hammer element 18 extends in a radial direction greater than at least one diameter D of the handle body 30. This provides more surface area for striking the drywall fasteners or other hammering tasks performed by users such as wallboard tapers or other tradesmen. In addition, the oversized hammer element 18 acts as a buffer for the end user's hand when striking the wall, reducing the possibility of pinching the hand. It should be noted that the “baseball bat”- type handle and hammer configuration may vary in size to suit the particular application.

The handle 16 described above and best seen in FIG. 1 may have at least one diameter D including a plurality of diameters of various sizes extending from the distal end 26 to the proximal end 28. An advantage of the preferred embodiment is that the largest diameter D of the plurality of diameters is smaller than the periphery 32 of the hammer element 18. The hammer element 18 is contemplated as being constructed of several different hard materials, the properties of which include strength, durability, and low malleability and ductility. It is envisioned that the preferred hammer element 18 is constructed of metal, preferably zinc.

As shown in FIG. 1, an axial length H of the hammer element 18 is most preferably 20-25 percent of an axial length L of the handle 16. However, the axial length H of the hammer element 18 is preferably in the approximate range of 15-30 percent of the axial length L of the handle 16.

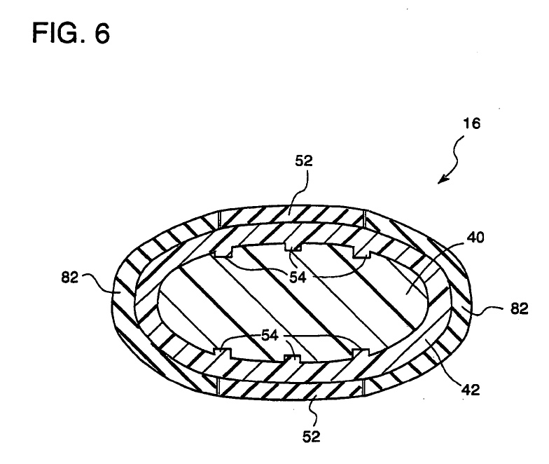

As shown in FIG. 6, the handle 16 has a generally elliptical cross-section for better handle comfort. The generally elliptical cross-section of the taping knife 10 preferably extends to a point directly adjacent the attachment edge 22 of the blade 12. This feature allows for placement of the hand closer to the blade 12 for greater control and use.

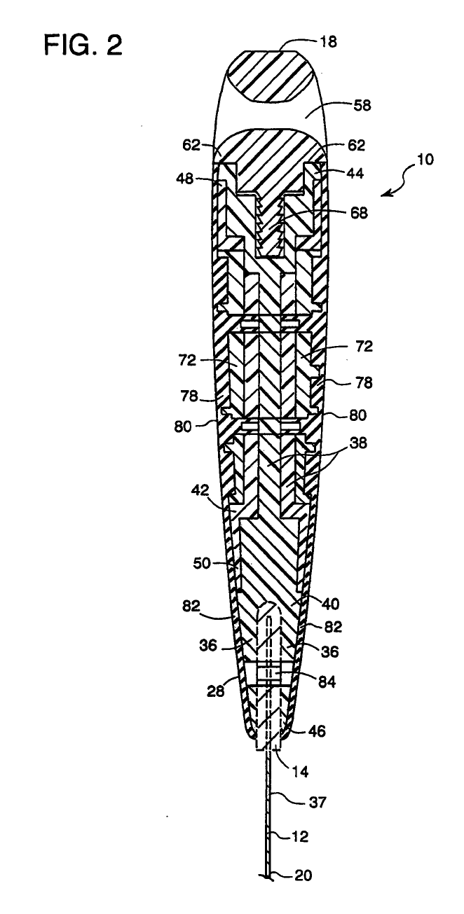

Referring now to FIGS. 1, 2, and 3, the proximal end 28 flares laterally greater than the width of the handle body 30. This configuration provides increased contact and support of the handle 16 with the blade 12, strengthening a failure point of traditional taping knives. As seen in FIG. 2, the proximal end 28 includes two lips 36 narrowing in thickness towards the working edge 20 of the blade 12. The lips 36 extend over the attachment edge 22, and over a portion of the backing plate 14, or, in narrower blades, over a web 37 of the blade 12.

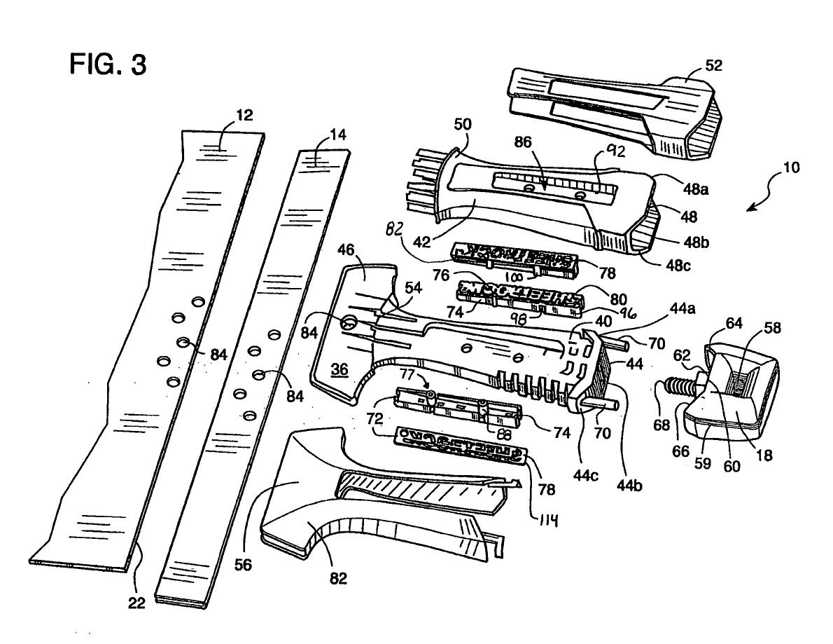

The preferred embodiment includes a core 38 (seen in FIG. 2) made up of an inner core 40 and an outer core 42 (seen in FIG. 3). The inner core 40 has a distal end 44 and a proximal end 46. Likewise, the outer core 42 has a distal end 48 and a proximal end 50. While other conventional fabrication techniques are contemplated, the inner core 40 is preferably made by injection molding. The outer core 42 is preferably integrally formed by overmolding over the inner core 40, and a resilient gripping region 52 is integrally formed by overmolding over the outer core 42. The technique of overmolding is well known in the art. It is contemplated that the inner core 40 has recess formations 54 for receiving the outer core 42 to increase the strength of the bond between them. Both the inner core 40 and the outer core 42 may be made of polypropylene for its strength, cost, and workability attributes. Other equivalent materials known to skilled practitioners are contemplated. The gripping region 52 may be made of Santoprene brand styrene-ethylene-butylene-styrene or other moldable, resilient, rubber-like materials known in the art.

Furthermore, the resilient gripping region 52 is preferably textured, as by corrugations or ribs for improved gripping characteristics, and may be provided in more than one portion. The textured surface prevents slippage when the hand becomes wet from perspiration or other liquids.

As shown in FIG. 1, the handle body 30 increases in diameter from the proximal end 28 to the distal end 26. In addition, the proximal end 28 flares laterally outward from a neck 56 of the handle 16 for providing support to the blade and also for providing additional gripping surface to the user. The hammer element 18 also has a relatively large eyelet 58 allowing the taping knife 10 to be hung up on a tool rack, hook, or other projection when not in use or to suspend the tool after use to facilitate drying.

The hammer element 18 abuts the distal end 26. A feature of the present knife 10 is that the hammer element 18 has portions that interlock with the distal end 26 allowing greater protection to the handle, especially when the user employs the side of the handle and hammer element as an impact tool, such as to set unseated nails. In the preferred embodiment, the hammer element 18 abuts the distal end 26 at at least one obtuse angle a relative to the extremity of the distal end 26 for dispersing impact forces in the lateral as well as axial directions. In addition, the angular design also protects a side 59 of the handle 16 farther down the length of the handle when compared to a non-angular design.

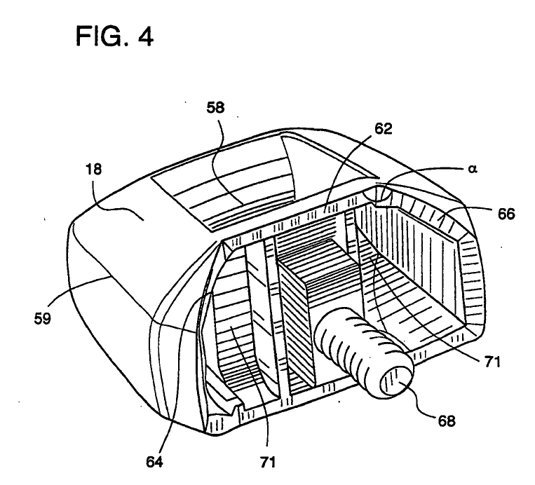

In the preferred embodiment a lower edge 60 (shown in FIG. 3) of the hammer element 18 has three segments (shown in FIG. 4), a central segment 62 is generally perpendicular to a longitudinal axis of the handle, and two end segments 64, 66, each defining the angle a with the central segment 62. In the preferred embodiment, a is approximately 135 degrees, however other angles are contemplated. As seen in FIG. 3, the distal ends 44 and 48 are provided with corresponding opposing surfaces 44a-c and 48a-c to positively engage the above-identified angled configuration of the lower edge 60 of the hammer element 18.

Referring now to FIGS. 3 and 4, the hammer element 18 is provided with at least one barbed peg 68 for attaching the hammer element 18 to the inner core 40. The barbs on the peg 68 securely retain the hammer element 18 in a corresponding bore (not shown) in the core 40 and prevent the hammer element from becoming severed from the inner core upon impact. Also, the inner core 40 includes at least one and preferably two unbarbed lugs 70 extending from the distal end 44 of the inner core 40. The two unbarbed lugs 70 mate with corresponding holes 71 in the hammer element 18 and prevent the hammer element from rotating about the single barbed peg 68.

Referring now to FIGS. 1, 3, 5 and 7-9, another feature of the present taping knife 10 is that the handle 16 is configurable so that the user will be able to identify the source manufacturer even after long-term use. Accordingly, the handle 16 has an identification insert 72 including a relatively hard portion 74 having a raised logo 76 and a plurality of protrusions 77 extending downwardly from the relatively hard portion, and a resilient portion 78 surrounding the raised logo 76 to form an inlaid appearance. The resilient portion 78 may be made of a rubber-like material as described in relation to the gripping region 52 upon assembly and is flush with an upper surface 80 of the logo 76. Constructing the logo 76 out of a relatively hard material allows the logo to last longer and, since it is made of integrally formed plastic rather than being painted or printed on the handle 16, makes the logo 76 resistant to rubbing or wearing off during use. Consequently, users will be able to associate the tool with its manufacturer for a longer period of time than conventional taping knives.

In addition, the resilient portion 78 surrounding the logo 76 provides comfort to the user's hand when holding the taping knife 10. Surrounding the hard portion 74 with the resilient rubber-like portion 78 is more comfortable than if the identification insert 72 was made entirely of a hard material. The resilient portion 78 may be made of Santoprene brand styrene-ethylene-butylene-styrene and the hard portion 74 of polypropylene. Those skilled in the art are familiar with equivalent alternatives for the above-identified materials.

Upon assembly, the attachment edge 22 is inserted into the reinforcing backing plate 14, then crimped and/or fastened in place. Next, the blade 12 is placed in a mold and the inner core 40 is formed, preferably by injection molding, however other production techniques are contemplated. During molding, the proximal end 28 of the inner core 40 flows over the reinforcing backing plate 14 and the attachment edge 22, securing these parts together without the use of rivets or other fasteners. This flowing plastic also prevents the seepage of moisture between the plastic handle 16 and the metal blade 12, which is known to cause failure in conventional taping knives. The preferred embodiment eliminates the need for rivets.

The inner core 40 and the blade 12 are then placed together in a mold and the outer core 42 is similarly formed, as by injection molding over the inner core 40. After that, an outer covering 82 of a resilient material is provided and formed over the outer core 42 to provide a soft gripping surface for the user. Santoprene brand styrene-ethylene-butylene-styrene or other moldable rubber-like materials may be used for the outer covering 82. The outer covering 82 is also preferably used to facilitate the attachment of the inner core 40 to the blade 12 and optionally the reinforcing backing plate 14. While the outer covering 82 may be provided in one step to cover the outer core 42, in the preferred embodiment the next step in the assembly process is to inject the resilient gripping region 52 as seen in FIG. 3. This gripping region 52 is applied over the outer core 42 and interlocks with the outer covering 82.

The identification insert 72 is assembled by forming the relatively hard portion 74 having the logo 76 and the plurality of protrusions 77, and then the resilient portion 78 is formed around it, preferably by overmolding. The identification insert 72 is then secured into an insert receiving area or recess 86 defined by the handle core 38, such as by a friction fit, with chemical adhesives, ultrasonic bonding or similar technologies (FIG. 3). Lastly, the hammer element 18 is fastened to the distal end 26 of the handle 16 and is secured by insertion of the barbed peg 68.

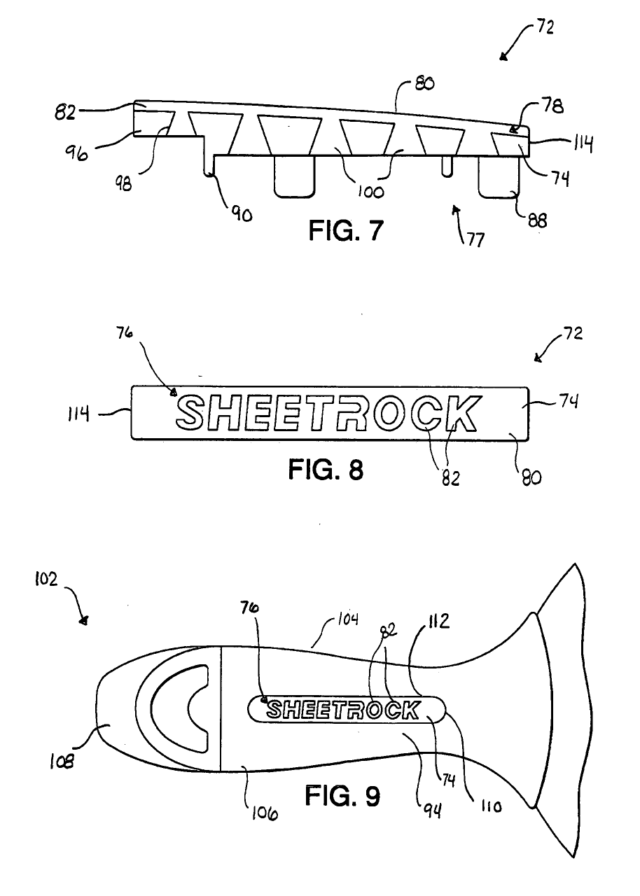

Referring now to FIG. 7, to enhance the positive engagement of the identification insert 72 into the handle, it is contemplated that the plurality of protrusions 77 includes at least one cylindrical protrusion 88 and at least one tab-shaped protrusion 90. However, it is appreciated that the number and type of protrusion may be variable, as is known in the art.

As shown in FIG. 3, the handle core recess 86 includes a plurality of openings 92, each configured for matingly engaging a corresponding one of the plurality of protrusions 77. After a press-fit insertion into the handle recess 86, upper surfaces of the raised logo 76 and the surrounding resilient portion 78 are flush with the upper surface 80 of the logo and an exterior surface 94 of the handle 16 (FIG. 9). Once installed, it is contemplated that the identification insert 72 will not be removable without damaging the handle 16.

Referring to FIGS. 3 and 7, the relatively hard portion 74 further includes a sidewall 96 depending from the raised logo 76. The sidewall 96 includes a plurality of galleries 98 configured for receiving fingers 100 of the resilient portion 78 upon overmolding. It is contemplated that this arrangement will provide a strong bond between the relatively hard portion 74 and the resilient portion 78, helping to prevent the resilient portion from separating from the relatively hard portion after continued use of the taping knife 10. However, it is recognized that other conventional bonding techniques, such as chemical adhesives, may be available for securing the resilient portion 78 to the relatively hard portion 74.

Referring to FIG. 9, an alternate embodiment of the present insert is generally designated 102 and is shown inserted in an alternate taping knife 104. The knife 104 incorporates the same type of handle construction as the tool 10 and identical components are designated with identical reference numbers. In the knife 104, the contours of a handle 106 are modified from those of the handle 16. Also, the hammer element 108 is streamlined in appearance relative to the hammer element 18, and does not extend radially beyond the handle 106. Regarding the insert 102, the main distinction between it and the insert 72 is that it has generally arcuate or rounded ends 110 which matingly engage the corresponding recess 112, corresponding to the recess 86. In the insert 72, respective ends 114 are provided with generally right angled corners.

To further enable source identification of the taping knife 10, it is contemplated that the identification insert 72,102 is provided so that the raised logo 76 is a distinct color from the resilient portion 78. It is preferred that the colored resilient portion 78 is made of a distinct color from the gripping region 82.

To enable wallboard tapers to more easily identify or personalize their taping knives, an identification kit is provided, including a plurality of identification inserts 72, each of the identification inserts individually insertable into the handle core recess 86, and each of the inserts 72 is provided with a different color. It is contemplated that providing each of the inserts 72 with a different color, especially in the resilient portion 78, will enable easy identification by the user of his or her particular taping knife 10. Thus personalization of the taping knives 10 is enhanced, and job site confusion of taping knife ownership is prevented. It is also contemplated that the kit can be sold with only the inserts 72 (as a replacement kit) or with both the taping knife 10 and the inserts, i.e., as an identification system.

While a particular embodiment of the present taping knife with identification insert has been described herein, it will be appreciated by those skilled in the art that changes and modifications may be made thereto without departing from the invention in its broader aspects and as set forth in the following claims.

1. A handle for a taping knife having a blade with a working edge and an attachment edge opposite the working edge, the handle comprising;
a handle core with distal and proximal ends, said proximal end associated with said attachment edge, said core defining a recess; and
an identification insert insertable into said handle core recess.

2. The handle for the taping knife of claim 1 wherein said handle core includes an inner core and an outer core molded over said inner core.

3. The handle for the taping knife of claim 1 wherein said insert includes a relatively hard portion and a resilient portion.

4. The handle for the taping knife of claim 3 wherein said insert relatively hard portion includes a raised logo and a plurality of protrusions extending downwardly from said relatively hard portion, said resilient portion configured for surrounding said raised logo to form an inlaid appearance.

5. The handle for the taping knife of claim 4 wherein said plurality of protrusions includes at least one of a cylindrical protrusion and a tab-shaped protrusion.

6. The handle for the taping knife of claim 5 wherein said handle core recess includes a plurality of openings each configured for engaging with a corresponding one of said plurality of protrusions.

7. The handle for the taping knife of claim 6 wherein after insertion into said handle recess, said raised logo and said surrounding resilient portion are flush with an exterior surface of said handle.

8. The handle for the taping knife of claim 4 wherein said relatively hard portion further includes a sidewall depending from said raised logo.

9. The handle for the taping knife of claim 8 wherein said sidewall includes a plurality of galleries configured for receiving fingers of said resilient portion.

10. An identification kit for a taping knife having a blade provided with a working edge and an attachment edge opposite the working edge, a handle with distal and proximal ends and a core, the proximal end associated with the attachment edge, the core defining a recess, the identification kit comprising:
a plurality of visually distinguishable identification inserts, each of said inserts individually insertable into the handle core recess.

11. The identification kit of claim 10 wherein each of said plurality of inserts is provided with a distinct color.

12. The identification kit of claim 11 wherein each of said plurality of inserts includes a relatively hard portion and a resilient portion.

13. The identification kit of claim 12 wherein said relatively hard portion includes a raised logo and a plurality of protrusions extending from said relatively hard portion, said resilient portion being configured for surrounding said raised logo to form an inlaid appearance.

14. The identification kit of claim 13 wherein said plurality of protrusions includes at least one of a cylindrical protrusion and a tab-shaped protrusion.

15. The identification kit of claim 13 wherein the handle core recess includes a plurality of openings each configured for engaging with a corresponding one of said plurality of protrusions in one of said plurality of inserts.

16. The identification kit of claim 12 wherein said relatively hard portion further includes a sidewall extending from said raised logo, said sidewall including a plurality of galleries configured for receiving fingers of said resilient portion.

17. A taping knife, comprising:
a blade having a working edge and an attachment edge opposite the working edge;
a handle with distal and proximal ends and a core provided with an inner core and an outer covering molded over said inner core, said proximal end associated with said attachment edge, said core defining a recess; and
an identification system including a plurality of identification inserts, each of said plurality of inserts independently insertable into said handle core recess and each of said plurality of inserts provided with a different color.

18. The taping knife of claim 17, wherein each of said plurality of inserts includes a relatively hard portion and a resilient portion, said relatively hard portion including a raised logo and a plurality of protrusions extending from said relatively hard portion, said resilient portion surrounding said raised logo to form an inlaid appearance.

19. The taping knife of claim 18 wherein said relatively hard portion further includes a sidewall extending from said raised logo, said sidewall including a plurality of galleries configured for receiving fingers of said resilient portion.

20. An identification insert for use with a taping knife having a blade provided with a working edge and an attachment edge opposite the working edge, a handle with distal and proximal ends and a core provided with an inner core and an outer covering molded over the inner core, the proximal end associated with the attachment edge, the core defining a recess, the insert comprising:
a relatively hard portion having a raised logo; and
a resilient portion configured for surrounding said raised logo to form an inlaid appearance;
wherein the insert is insertable into the handle core recess.

21. The insert of claim 20 wherein said relatively hard portion further includes a plurality of protrusions extending therefrom and a sidewall extending from said raised logo, said sidewall having a plurality of galleries configured for receiving fingers of said resilient portion.
